(19) United States
(12) Patent Application Publication
(10) Pub. No.: US 2023/0055170 A1
(43) Pub. Date: Feb. 23, 2023

(54) AIRCRAFT TIRE

(71) Applicant: The Goodyear Tire & Rubber Company, Akron, OH (US)

(72) Inventor: Ceyhan Celik, Stow, OH (US)

(21) Appl. No.: 17/404,073

(22) Filed: Aug. 17, 2021

(51) Int. Cl. B60C 9/22; B60C 9/00

(52) U.S. Cl. CPC B60C 9/2204; B60C 9/0064; B60C 2200/02

(57) ABSTRACT

A tire for use under heavy loads and high speeds includes a tread, a crown reinforcement, a carcass reinforcement with at least one ply wound about a pair of bead cores, and a cut/puncture resistant breaker layer disposed radially adjacent the crown reinforcement and radially inside the tread. The cut/puncture resistant breaker layer is formed of monofilaments inclined at between about 0 degrees and about 10 degrees relative to an equatorial plane of the tire.

### FIELD OF THE INVENTION

The present invention relates to a tire with radial carcass reinforcement intended to support heavy loads and inflated to relatively high pressures for high speed use, in particular an airplane tire. Alternatively, the airplane tire may be non-pneumatic.

### BACKGROUND OF THE INVENTION

For purposes of this patent application, the phrase “for a high speed under a heavy load” shall be understood to mean operation of the tire under at least one of conditions that the load subjected to the tire is remarkably high and that a centrifugal force acting on the ground contact zone of the tire, when the tire rotates at a high speed, becomes significantly large and must be taken into consideration. For example, a conventional tire may operate under especially severe conditions as in the case of aircraft and/or similar high speed transport tires subjected to a heavy load. The tire must be suitably sturdy/robust for such a severe condition.

One conventional tire, used under the above mentioned conditions, may include a side wall portion, a tread portion, a hump portion having a particularly large thickness, and a case reinforcing ply. The entire case reinforcing ply may extend from one of bead cores to the other bead core. The case reinforcing ply may be provided at its outermost layer with a breaker for the purpose of improving cut and/or puncture resistance of the tire.

In such a conventional tire, the case reinforcing ply may include plies which are substantially the same in number from the center of the tread portion through the hump portion to the side wall portion and which are uniform in thickness distribution. This thickness distribution may be substantially the same even when the case reinforcing ply is provided at its outermost layer with the cut/puncture resistant breaker.

The cut/puncture resistant breaker may mitigate a decrease of the crown radius of the tire induced by high speed rotation and corresponding centrifugal force. Such a reduction in a decrease in crown radius may thereby also improve the load-bearing-ability of the tire for high speed under a heavy load.

### SUMMARY OF THE INVENTION

A first tire for use under heavy loads and high speeds, in accordance with the present invention, includes a tread, a crown reinforcement, a carcass reinforcement with at least one ply wound about a pair of bead cores, and a cut/puncture resistant breaker layer disposed radially adjacent the crown reinforcement and radially inside the tread. The cut/puncture resistant breaker layer is formed of monofilaments inclined at between about 0 degrees and about 10 degrees relative to an equatorial plane of the tire.

According to another aspect of the first tire, the cut/puncture resistant breaker layer is disposed adjacent a radially outer surface of a belt structure of the crown reinforcement.

According to still another aspect of the first tire, the cut/puncture resistant breaker layer is disposed adjacent a radially outer surface of an overlay structure of the crown reinforcement.

According to yet another aspect of the first tire, the cut/puncture resistant breaker layer is disposed adjacent a radially inner surface of an overlay structure of the crown reinforcement.

According to still another aspect of the first tire, the cut/puncture resistant breaker layer is disposed radially between a first belt of a belt structure of the crown reinforcement and a second belt of the belt structure of the crown reinforcement.

According to yet another aspect of the first tire, the cut/puncture resistant breaker layer is disposed radially between a belt structure of the crown reinforcement and an overlay structure of the crown reinforcement.

According to still another aspect of the first tire, the cut/puncture resistant breaker layer is disposed radially between an undertread of the tread and the crown reinforcement.

According to yet another aspect of the first tire, the cut/puncture resistant breaker layer is disposed radially adjacent a radially outer surface of the carcass reinforcement.

According to still another aspect of the first tire, each of the monofilaments are inclined between 5 degrees and 10 degrees relative to the equatorial plane of the tire.

According to yet another aspect of the first tire, each of a first plurality of monofilaments are parallel to each of the remaining first plurality of monofilaments.

According to still another aspect of the first tire, each of a second plurality of monofilaments are parallel to each of the remaining second plurality of monofilaments.

According to yet another aspect of the first tire, each of the first plurality of monofilaments have a first angle of inclination relative to the equatorial plane of the tire and each of the second plurality of monofilaments have a second angle of inclination relative to the equatorial plane of the tire, the first angle being equal and opposite the second angle.

According to still another aspect of the first tire, the cut/puncture resistant breaker layer is formed by spirally winding a single monofilament around a radially outer surface of the crown reinforcement.

According to yet another aspect of the first tire, the cut/puncture resistant breaker layer is formed by spirally winding a single monofilament radially between a first belt layer of a belt structure of the crown reinforcement and a second belt layer of the belt structure of the crown reinforcement.

According to still another aspect of the first tire, the monofilaments are formed from textile fibers.

A second tire for use under heavy loads and high speeds, in accordance with the present invention, includes a tread, a crown reinforcement, a carcass reinforcement with at least one ply wound about a pair of bead cores, and a cut/puncture resistant breaker layer disposed radially adjacent the crown reinforcement and radially inside the tread. The cut/puncture resistant breaker layer is formed of parallel monofilaments inclined at about 0 degrees relative to an equatorial plane of the tire.

According to another aspect of the second tire, the cut/puncture resistant breaker layer is disposed adjacent a radially outer surface of an overlay structure of the crown reinforcement.

According to still another aspect of the second tire, the cut/puncture resistant breaker layer is disposed radially between an undertread of the tread and the crown reinforcement.

According to yet another aspect of the second tire, the cut/puncture resistant breaker layer is formed by spirally winding a single monofilament around a radially outer surface of the crown reinforcement.

According to still another aspect of the second tire, monofilaments are formed from textile fibers.

### Definitions

As used herein and in the claims:

“Apex” means an elastomeric filler located radially above the bead core and between the plies and the turnup ply.

“Annular” means formed like a ring.

“Aramid” and “Aromatic polyamide” both mean a manufactured fiber in which the fiber-forming substance is generally recognized as a long chain of synthetic aromatic polyamide in which at least 85% of the amide linkages are attached directly to the two aromatic rings. Representative of an aramid or aromatic polyamide is a poly (p-phenyleneterephthalamide).

“Aspect ratio” means the ratio of a tire section height to its section width. For example, the aspect ratio may be the maximum axial distance between the exterior of the tire sidewalls when unloaded and inflated at normal pressure, multiplied by 100% for expression as a percentage. Low aspect ratio may mean a tire having an aspect ratio of 65 and below.

“Aspect ratio of a bead cross-section” means the ratio of a bead section height to its section width.

“Asymmetric tread” means a tread that has a tread pattern not symmetrical about the centerplane or equatorial plane (EP) of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls, and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Cord twist” means each yarn of the cord has its component filaments twisted together a given number of turns per unit of length of the yarn (usually expressed in turns per inch (TPI) or turns per meter (TPM)) and additionally the yarns are twisted together a given number of turns per unit of length of the cord. The direction of twist refers to the direction of slope of the spirals of a yarn or cord when it is held vertically. If the slope of the spirals conforms in direction to the slope of the letter “S”, then the twist is called “S” or “left hand”. If the slope of the spirals conforms in direction to the slope of the letter “Z”, then the twist is called “Z” or “right hand”. An “S” or “left hand” twist direction is understood to be an opposite direction from a “Z” or “right hand” twist. “Yarn twist” is understood to mean the twist imparted to a yarn before the yarn is incorporated into a cord, and “cord twist” is understood to mean the twist imparted to two or more yarns when they are twisted together with one another to form a cord. “dtex” is understood to mean the weight in grams of 10,000 meters of a yarn before the yarn has a twist imparted thereto.

“Cut belt ply” refers to a belt having a width less than the tread width, which lies flat over the carcass plies in the crown area of the tire.

“Crown” means that portion of the tire in the proximity of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Evolving tread pattern” means a tread pattern, the running surface of which, which is intended to be in contact with the road, evolves with the wear of the tread resulting from the travel of the tire against a road surface, the evolution being predetermined at the time of designing the tire, so as to obtain adhesion and road handling performances which remain substantially unchanged during the entire period of use/wear of the tire, no matter the degree of wear of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made, that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360° rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Monofilament” means a single, generally large filament of synthetic fiber

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead and the ply is laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” means stress expressed as force per unit linear density of the unstrained specimen (cN/tex).

“Tensile stress” is force expressed in force/cross-sectional area. Strength in psi=12,800 times specific gravity times tenacity in grams per denier.

“Tension” for a cord means force on the cord expressed as mN/tex.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turns per inch”, or TPI, means turns of cord twist for each inch length of cord.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

Vertical deflection” means the amount that a tire deflects under load.

“Warp” means, in weaving/forming of fabric, lengthwise or longitudinal warp yarns, filaments, threads, cables, fibers, and/or cords may be held stationary in tension on a frame or loom while transverse “weft” yarns, filaments, threads, cables, fibers, and/or cords may be drawn through, and inserted over-and-under, the warp yarns, filaments, threads, fibers, and/or cords.

“Weft” means, in weaving/forming of fabric, transverse yarns, filaments, threads, cables, fibers, and/or cords may be drawn through, and inserted over-and-under, “warp” yarns, filaments, threads, cables, fibers, and/or cords. A single weft yarn, filament, thread, cable, fiber, and/or cord of a weft crossing the “warp” yarns, filaments, threads, cables, and/or cords may be termed a “pick”. Conventional weft yarns, filaments, threads, cables, fibers, and/or cords may only function to maintain the lateral spacing of the “warp” yarns, filaments, threads, cables, fibers, and/or cords during assembly and pre-installation handling.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF THE DRAWINGS

The present invention will be described by way of example and with reference to the accompanying drawings, in which:

FIG. 1 is a schematic cross sectional view of an example tire for use with the present invention;

FIG. 2 is a schematic cross sectional view of the bead of the example tire of FIG. 1;

FIG. 3 is a schematic additional view of the bead of FIG. 2; and

FIG. 4 is a cross sectional view of a ply reinforcement in accordance with the present invention.

### DETAILED DESCRIPTION OF EXAMPLES OF THE PRESENT INVENTION

The following language is of the best presently contemplated mode or modes for carrying out the present invention. This description is made for the purpose of illustrating the general principals of the present invention and should not be interpreted as a limitation of the appended claims. The scope of the present invention may be best determined by reference to the appended claims.

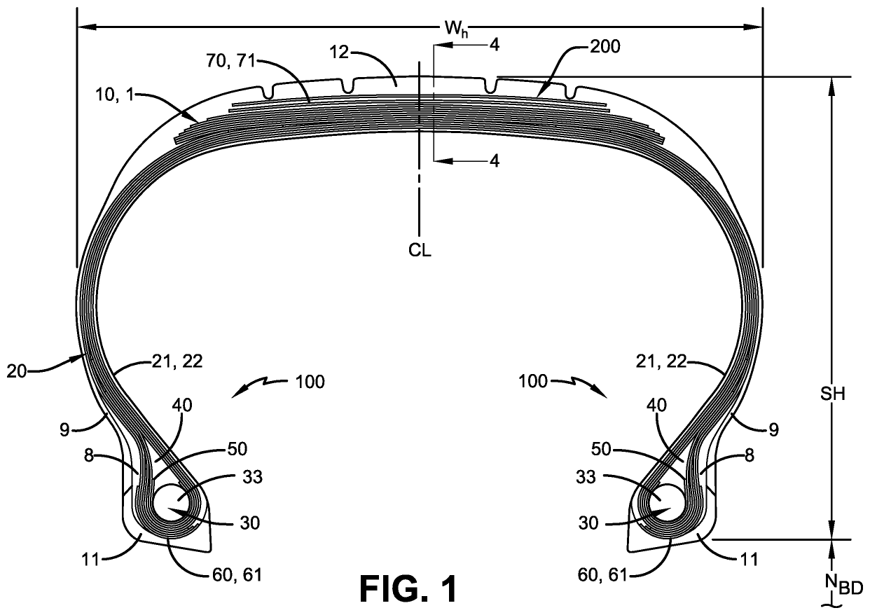

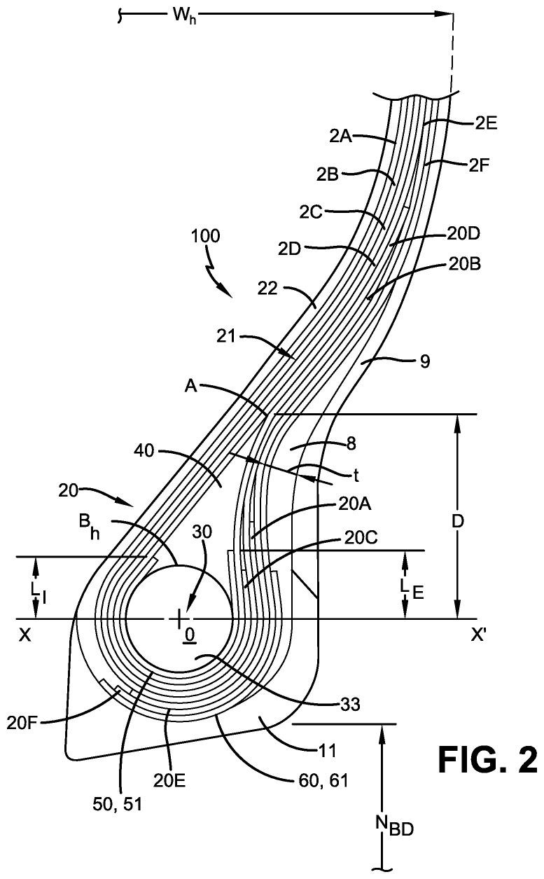

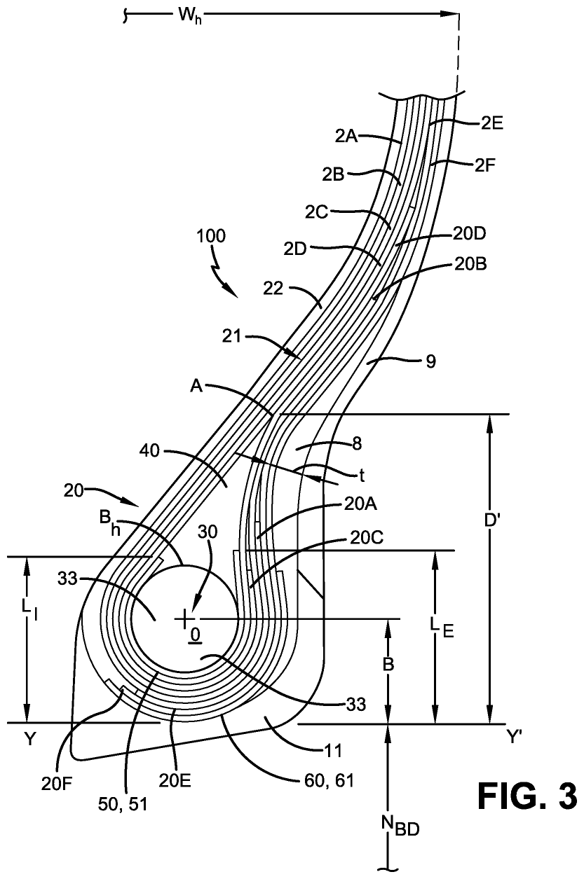

FIG. 1 illustrates an exemplary aircraft tire 100 for use with the present invention. The tire 100 may have a tread 12 with sidewall portions 9 connected to, and extending from, the lateral edges of the tread 12. At the radially inner ends of each sidewall 9 may be a bead portion 30. Each bead portion 30 may have therein a bead core 33, an apex 40 extending radially outward from the bead core 33, and at least one chafer layer 60 reinforced with cords 61 to reduce rim chafing of the tire 100. A carcass reinforcing ply structure 20 may extend from one bead portion 30 to the opposing bead portion 30 with turnup portions as shown. In greater detail, the exemplary tire 100 of FIG. 1 may be illustrated by the diagrammatic cross-section views of FIGS. 2 and 3.

With reference to FIGS. 2 and 3, the carcass reinforcement 20 may be formed of six plies 2A to 2F of radial textile cords 21. Among these six plies, four axially inner plies 2A, 2B, 2C and 2D may be wound around each circular bead core 33. These four plies may extend from the inside to the outside of the tire 100 in order to form turn-ups 20A, 20B, 20C and 20D. The carcass reinforcement 20 may be radially outward of the innerliner 22 of tire 100.

Outward of the bead cores 33 may be a strip or filler 40 of elastomeric material having a substantially triangular shape extending to an apex A radially furthest from the rotation axis of the tire 100 and located a distance D from a reference line XX′. As shown in FIG. 1, the reference line may also be parallel to the axis of rotation and pass through the geometric center O of the circle circumscribed on the cross section of the bead core 33.

A flipper 50, which can be formed of radial textile cords 51 similar to those of plies 20, may be located with an inner end L_{I} slightly above the height Bₕ of the bead core 33 and an outer end L_{E} may also be slightly above the bead core 33 as measured from line YY′. The ends L_{I}, L_{E} may satisfy a relationship wherein Bₕ<L_{I} and L_{E}<0.7D, as measured from the nominal bead diameter NBD. To minimize the space occupied by the flipper 50, the cords 51 may be made of a diameter smaller than the ply cords 21.

The carcass may further have two carcass plies 2E and 2F herein called outer plies. These outer plies 2E, 2F may cover the turn-ups 20A through 20D of the inner plies 2A through 2D. The outer plies 2E and 2F may be wound around the bead core 33 over a portion of the circular arc radially outside of the center of bead core 33. The ply ends 20E and 20F may thus be disposed axially inward of the lowest portion of the bead core 33. The ends 20E and 20F may effectively be pinched between the bead core 33 and the rim seat thereby securely anchoring the outer plies 2E, 2F.

The tire bead may have an outer chipper 60 of textile cords 61 wrapped around the ends 20E and 20F assuring protection of the carcass plies against damage during mounting. Radially below the chipper 60 may be a chafer 11 having a rubber gauge in the range between about 0.04 inches (1.0 mm) and about 0.16 inches (4.1 mm).

Axially outward of the chafer 11 and the plies 20E and 20F may be an elongated strip 8 of elastomeric material extending from radially inward of the bead 30 adjacent the chafer 11 to a radial location at, or slightly above, the turn-up 20B, but below the turn-up 20D. As shown, this strip 8 may be interposed between the sidewall rubber 9 and the outer ply 20F. At a location almost equal to the radial height D of the apex A, the strip 8 may have a maximum thickness t of 0.3 inches (7.6 mm).

Referring back to FIG. 1, radially outward of the carcass 20 may be a belt structure 10. The belt structure 10 may have at least belt two ply layers of cords 1 inclined at an angle between 5 degrees to 35 degrees. The cords 1 in each belt ply layer may be parallel to each other and crossed relative to the cords 1 in the adjacent belt ply layer. The radial carcass reinforcement may be radially surmounted by the crown reinforcement, or belt structure 10, formed of a plurality of textile layers of reinforcement elements or cords 1 which are inclined relative to the circumferential direction by a predetermined angle. So as to avoid the free ends of crown/belt plies, the layers may be laying out by winding, around a cylindrical or rounded form or a carcass reinforcement blank, a strip of at least one textile reinforcement element or cord 1 from one axial edge of the layer to the other thereby forming the desired angle with the equatorial plane of the tire 100.

Outward of the belt structure 10 may be an overlay ply 70. The overlay ply 70 is shown in FIG. 1 radially outward of the belt plies 10, but such an overlay ply 70 may also be located radially inward of the belt plies 10 or between two of the belt plies 10. The overlay ply 70 may be formed of cords 71 inclined at between about 5 degrees and 10 degrees relative to the equatorial plane of the tire 100. The inclination angle of the cords 71 may be partially dependent upon the formation and application method of the overlay ply 70. The overlay ply 70 may be spirally wound onto a tire building machine—with spiral winding of a single elastomeric encased cord or an elastomeric ribbon of multiple cords having a width between 5 mm and 30 mm and a cord density in a range between about 10 ends per inch (25.4 ends per cm) and about 50 ends per inch (130 ends per cm). The overlay ply 70 may also be a cut ply of parallel cords 71. A spirally wound layer may have a greater inclination angle relative to the equatorial plane than a cut ply of parallel cords 71. Each of the elements described above may employ the textile cords 1, 21, 51, 61, and/or 71 including the carcass plies 20, the belt plies 10 or strips, the chafer 60, the flipper 50, and/or the overlay 70.

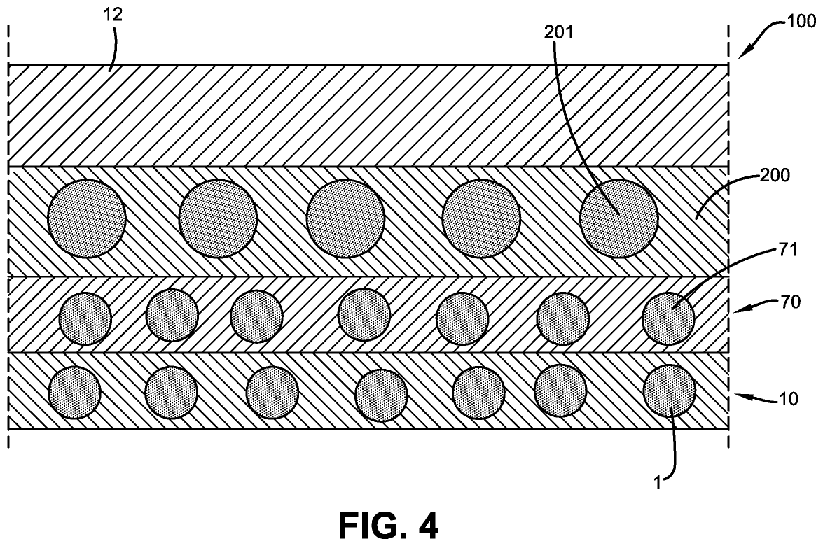

In accordance with the present invention, one of more cut/puncture resistant breaker layers 200 may be disposed adjacent a radially outer surface of the overlay 70 (FIGS. 1 & 4) and radially inside the tread 12, adjacent a radially outer surface of the belt structure 10 radially inside the overlay, and/or radially between layers of the overlay 70 and/or belt structure 10. The cut/puncture resistant breaker layer(s) 200 may be formed of monofilaments 201 inclined between about 5 degrees and about 10 degrees relative to the equatorial plane of the tire 100. The inclination angle of the cords 201 may be partially dependent upon the formation and application method of the cut/puncture resistant breaker layer(s) 200. The cut/puncture resistant breaker layer(s) 200 may also be spirally wound onto a tire building machine—with spiral winding of a single elastomeric encased monofilament 201 or an elastomeric ribbon of multiple monofilaments 201 having a width between 5 mm and 30 mm and a density in a range between about 10 ends per inch (25.4 ends per cm) and about 50 ends per inch (130 ends per cm). The cut/puncture resistant breaker layer(s) 200 may also be a cut ply of parallel cords 201 (FIG. 4). A spirally wound layer may have a greater inclination angle relative to the equatorial plane than a cut ply 200 of parallel cords 201. The cut/puncture resistant breaker layer(s) 200 may employ textile and/or steel monofilaments 201. The cut/puncture resistant breaker layers 200 may be paired with a first layer having parallel monofilaments 201 inclined at a first angle relative to the equatorial plane of the tire 100 and a second layer having parallel monofilaments 201 inclined at an equal and opposite second angle relative to the equatorial plane of the tire, similar to belt structures, such as the belt structure 10.

Variations in the present invention are possible in light of the description of it provided herein. While certain representative examples and details have been shown for the purpose of illustrating the subject invention, it will be apparent to those skilled in this art that various changes, modifications, equivalents may be made therein without departing from the scope of the subject invention. It is, therefore, to be understood that changes may be made in the particular examples described herein which will be within the fully intended scope of the present invention as defined by the following appended claims.

What is claimed:

1. A tire for use under heavy loads and high speeds comprising:
a tread;
a crown reinforcement;
a carcass reinforcement with at least one ply wound about a pair of bead cores; and
a cut/puncture resistant breaker layer disposed radially adjacent the crown reinforcement and radially inside the tread, the cut/puncture resistant breaker layer is formed of monofilaments inclined at between about 0 degrees and about 10 degrees relative to an equatorial plane of the tire.

2. The tire as set forth in claim 1 wherein the cut/puncture resistant breaker layer is disposed adjacent a radially outer surface of a belt structure of the crown reinforcement.

3. The tire as set forth in claim 1 wherein the cut/puncture resistant breaker layer is disposed adjacent a radially outer surface of an overlay structure of the crown reinforcement.

4. The tire as set forth in claim 1 wherein the cut/puncture resistant breaker layer is disposed adjacent a radially inner surface of an overlay structure of the crown reinforcement.

5. The tire as set forth in claim 1 wherein the cut/puncture resistant breaker layer is disposed radially between a first belt of a belt structure of the crown reinforcement and a second belt of the belt structure of the crown reinforcement.

6. The tire as set forth in claim 1 wherein the cut/puncture resistant breaker layer is disposed radially between a belt structure of the crown reinforcement and an overlay structure of the crown reinforcement.

7. The tire as set forth in claim 1 wherein the cut/puncture resistant breaker layer is disposed radially between an undertread of the tread and the crown reinforcement.

8. The tire as set forth in claim 1 wherein the cut/puncture resistant breaker layer is disposed radially adjacent a radially outer surface of the carcass reinforcement.

9. The tire as set forth in claim 1 wherein each of the monofilaments are inclined between 5 degrees and 10 degrees relative to the equatorial plane of the tire.

10. The tire as set forth in claim 1 wherein each of a first plurality of monofilaments are parallel to each of the remaining first plurality of monofilaments.

11. The tire as set forth in claim 10 wherein each of a second plurality of monofilaments are parallel to each of the remaining second plurality of monofilaments.

12. The tire as set forth in claim 11 wherein each of the first plurality of monofilaments have a first angle of inclination relative to the equatorial plane of the tire and each of the second plurality of monofilaments have a second angle of inclination relative to the equatorial plane of the tire, the first angle being equal and opposite the second angle.

13. The tire as set forth in claim 1 wherein the cut/puncture resistant breaker layer is formed by spirally winding a single monofilament around a radially outer surface of the crown reinforcement.

14. The tire as set forth in claim 1 wherein the cut/puncture resistant breaker layer is formed by spirally winding a single monofilament radially between a first belt layer of a belt structure of the crown reinforcement and a second belt layer of the belt structure of the crown reinforcement.

15. The tire as set forth in claim 1 wherein the monofilaments are formed from textile fibers.

16. A tire for use under heavy loads and high speeds comprising:
a tread;
a crown reinforcement;
a carcass reinforcement with at least one ply wound about a pair of bead cores; and
a cut/puncture resistant breaker layer disposed radially adjacent the crown reinforcement and radially inside the tread, the cut/puncture resistant breaker layer is formed of parallel monofilaments inclined at about 0 degrees relative to an equatorial plane of the tire.

17. The tire as set forth in claim 16 wherein the cut/puncture resistant breaker layer is disposed adjacent a radially outer surface of an overlay structure of the crown reinforcement.

18. The tire as set forth in claim 16 wherein the cut/puncture resistant breaker layer is disposed radially between an undertread of the tread and the crown reinforcement.

19. The tire as set forth in claim 16 wherein the cut/puncture resistant breaker layer is formed by spirally winding a single monofilament around a radially outer surface of the crown reinforcement.

20. The tire as set forth in claim 16 wherein monofilaments are formed from textile fibers.
